(19) United States
(12) Patent Application Publication
(10) Pub. No.: US 2010/0158363 A1
(43) Pub. Date: Jun. 24, 2010

(54) SYSTEM AND METHOD TO DETECT SKIN COLOR IN AN IMAGE

(75) Inventors: XIAOYUN JIANG, San Diego, CA (US); Szepo R. Hung, Carlsbad, CA (US); Hsiang-Tsun Li, San Diego, CA (US); Babak Forutanpour, Carlsbad, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/340,545

(22) Filed: Dec. 19, 2008

(51) Int. Cl. G06K 9/00

(52) U.S. Cl. 382/165

(57) ABSTRACT

In a particular embodiment, a method is disclosed that includes performing a first test using a first pixel value of a pixel to determine whether the pixel is outside a skin color region of a color space. The method includes, when the first test does not identify the pixel as outside the skin color region, performing a second test using a second pixel value of the pixel to determine whether the pixel is outside the skin color region of the color space. The method further includes, when the second test does not identify the pixel as outside the skin color region, performing a third test using a third pixel value of the pixel to determine whether the pixel is outside the skin color region of the color space.

### I. FIELD OF THE DISCLOSURE

The present disclosure is generally directed to a system and method to detect skin color in an image.

### II. BACKGROUND

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless telephones include other types of devices that are incorporated therein. For example, wireless telephones can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Digital signal processors (DSPs), image processors, and other processing devices are frequently used in portable personal computing devices that include digital cameras, or that display image or video data captured by a digital camera. Such processing devices can be utilized to provide video and audio functions, to process received data such as image data, or to perform other functions.

One type of image processing involves skin color detection. Skin color detection in an image may be used to guide an image capturing device in the focusing of the image. Skin color detection in an image may also be used to guide an image capturing device in the determination of exposure settings and the like. Skin color detection in an image may also be used in the encoding and compression of portions of the image. However, skin tone area has large variations in appearance, changing in color and shape and being affected by the intensity, color, and location of the light sources.

### III. SUMMARY

In a particular embodiment, a method is disclosed that includes performing a first test using a first pixel value of a pixel to determine whether the pixel is outside a skin color region of a color space, the first pixel value corresponding to a first component of the color space. The method includes, when the first test does not identify the pixel as outside the skin color region, performing a second test using a second pixel value of the pixel to determine whether the pixel is outside the skin color region of the color space, the second pixel value corresponding to a second component of the color space. The method further includes, when the second test does not identify the pixel as outside the skin color region, performing a third test using a third pixel value of the pixel to determine whether the pixel is outside the skin color region of the color space, the third pixel value corresponding to a third component of the color space. The method also includes identifying the pixel as not corresponding to a skin portion of an image in response to any of the first test, the second test, or the third test indicating that the pixel is outside the skin color region of the color space.

In another embodiment, a method is disclosed that includes receiving image data corresponding to an image, the image data including color values corresponding to a plurality of pixels. The method also includes using a hue value, a saturation value, and a luminance value to determine whether a particular pixel does not correspond to a skin region of the image.

In another embodiment, an apparatus is disclosed that includes first circuitry to perform a first test using first parameters to determine whether a pixel has a hue corresponding to a skin hue range. The apparatus also includes second circuitry to perform a second test using second parameters to determine whether the pixel has a luminance corresponding to a skin luminance range. The apparatus further includes third circuitry to perform a third test using third parameters to determine whether the pixel has a saturation corresponding to a skin saturation range.

In another embodiment, a computer-readable medium is disclosed. The computer-readable medium includes computer executable instructions that are executable to cause a computer to receive image data corresponding to an image, the image data including color values corresponding to a plurality of pixels. The computer executable instructions are further executable to cause the computer to use a hue value, a saturation value, and a luminance value to determine when a particular pixel corresponds to a skin region of the image.

In another embodiment, a computer-readable medium is disclosed. The computer-readable medium includes computer executable instructions that are executable to cause a computer to use a plurality of images to locate a skin color region in an HSV color space having a hue component, a saturation component, and a value component. The computer executable instructions are further executable to cause the computer to determine luminance values, blue chrominance values, and red chrominance values that map into the skin color region in the HSV color space. The computer executable instructions are further executable to cause the computer to determine an upper luminance value, a lower luminance value, an upper blue chrominance value, a lower blue chrominance value, an upper red chrominance value, and a lower red chrominance value for the skin color region in the HSV color space. The computer executable instructions are further executable to cause the computer to generate a lookup table covering respective ranges from the lower luminance value to the upper luminance value, from the lower blue chrominance value to the upper blue chrominance value, and from the lower red chrominance value to the upper red chrominance value, each of the respective ranges subsampled by two.

One particular advantage provided by disclosed embodiments is that a newly defined HSY color space having a hue component, a saturation component, and a luminance component is used to better define the range of skin color in an image with parameters having a similar range and precision, where the ranges of the skin color areas are easily defined, making parameter tuning easier.

Another advantage provided by disclosed embodiments is skin color detection that is fast, and effective, and may be performed at a device having relatively limited processing capability.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of an image capture system that includes an image capture device coupled to an image processing system having skin color detection and skin tone map generation;

FIG. 2 is a block diagram of a particular illustrative embodiment of a skin color detection apparatus;

FIG. 3 is a block diagram of a particular illustrative embodiment of a skin color detection apparatus having a lookup table;

FIG. 4 is a diagram of a particular illustrative embodiment of ranges of parameters defining a skin color region in an HSY color space having a hue component, a saturation component, and a luminance component;

FIG. 5 is a flow diagram of a first illustrative embodiment of a method to detect skin color in an image;

FIG. 6 is a flow diagram of a second illustrative embodiment of a method to detect skin color in an image;

FIG. 7 is a flow diagram of a third illustrative embodiment of a method to detect skin color in an image;

FIG. 8 is a block diagram of a particular embodiment of a device including a skin tone map generation module;

FIG. 9 is a block diagram of a particular embodiment of a portable communication device including a skin tone map generation module; and

FIG. 10 is a block diagram of a particular embodiment of an image processing tool having image editing software using a skin tone map.

### V. DETAILED DESCRIPTION

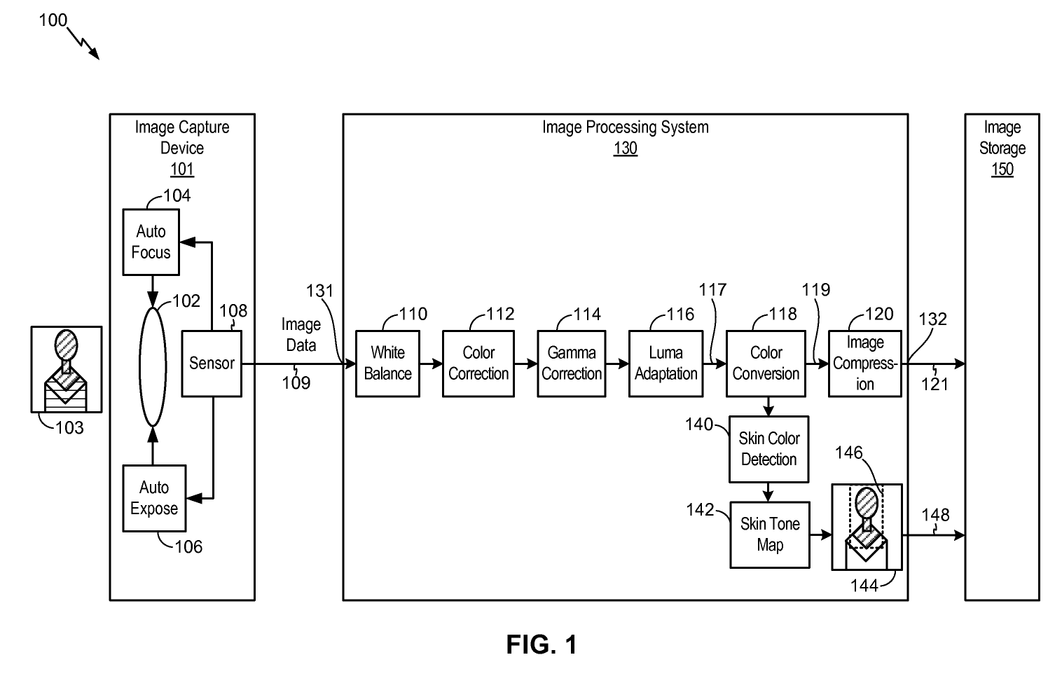

Referring to FIG. 1, an image capture system 100 is illustrated. The image capture system 100 includes an image capture device 101 coupled to an image processing system 130. The image processing system 130 is coupled to an image storage 150. The image storage 150 may be a random access memory (RAM) device or a non-volatile memory device such as a read-only memory (ROM) or flash memory. The image capture device 101 includes a sensor 108 coupled to an autofocus controller 104 and to an autoexposure controller 106. The autofocus controller 104 and the autoexposure controller 106 are each coupled to a lens system 102.

An image 103 is autofocussed and autoexposed through the lens system 102 and is sensed by the sensor 108. Image data is output from the sensor 108, as shown by the arrow 109, and input to the image processing system 130 at an entrance 131 to an image processing pipeline. The image data is successively processed by a white balance device 110, a color correction device 112, a gamma correction device 114, and a luma adaptation device 116 before being input, as shown at 117, to a color conversion device 118. The processed image data is input, as shown at 119, to an image compression device 120 and output from the image processing system 130 at an exit 132 from the image processing pipeline, as shown by the arrow 121, and input to the image storage 150. After color conversion in the color conversion device 118, the processed image data is also input to a skin color detection apparatus 140. The skin color detection apparatus 140 is coupled to a skin tone map device 142 that generates a skin tone map 144 that may have a window 146 framing a skin color portion of the image 103.

The skin color detection apparatus 140 may perform a series of sequential tests to determine whether a pixel should be classified as having a skin tone. For example, the skin color detection apparatus 140 may perform a first test using a first pixel value of a pixel to determine whether the pixel is outside a skin color region of a color space, the first pixel value corresponding to a first component of the color space. When the first test does not identify the pixel as outside the skin color region, the skin color detection apparatus 140 may perform a second test using a second pixel value of the pixel to determine whether the pixel is outside the skin color region of the color space, the second pixel value corresponding to a second component of the color space. When the second test does not identify the pixel as outside the skin color region, the skin color detection apparatus 140 may perform a third test using a third pixel value of the pixel to determine whether the pixel is outside the skin color region of the color space, the third pixel value corresponding to a third component of the color space. The skin color detection apparatus 140 may identify the pixel as not corresponding to a skin portion of an image in response to any of the first test, the second test, or the third test indicating that the pixel is outside the skin color region of the color space.

The skin tone map 144 may have many uses. For example, the autoexposure controller 106 may be configured to receive the skin tone map 144 to determine an exposure setting based on a region of the image 103 having skin color. Similarly, the autofocus controller 104 may be configured to receive the skin tone map 144 to focus based on the window 146 of the image 103 having skin color. The skin tone map 144 may also be used in conjunction with the image compression device 120 to compress the skin color portions of the image 103 differently than the non-skin color portions of the image 103.

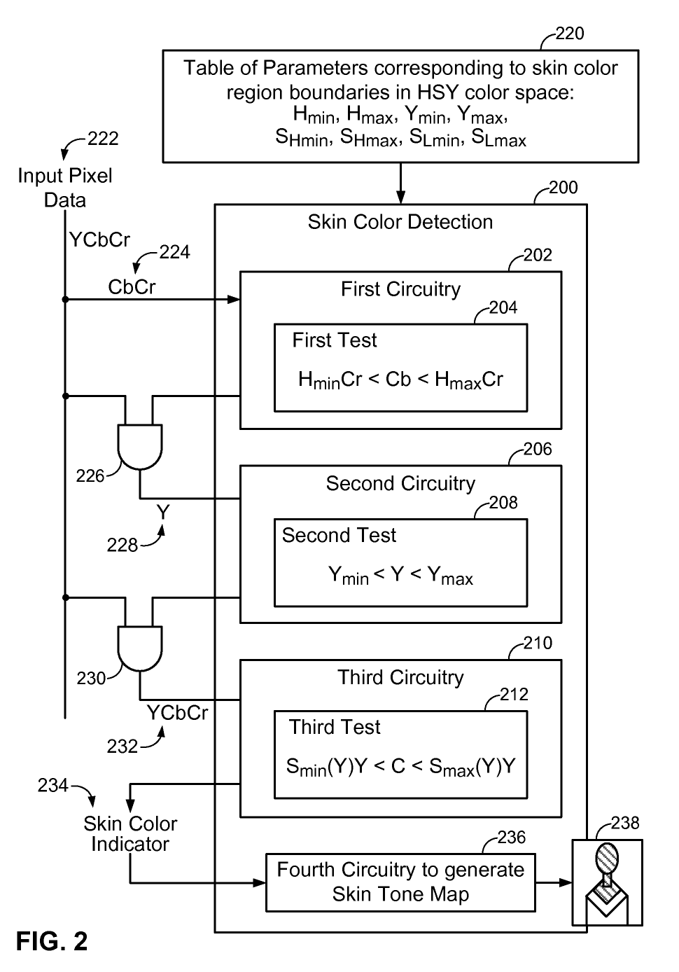

Referring to FIG. 2, a particular illustrative embodiment of a skin color detection apparatus 200 is depicted. In a particular embodiment, the skin color detection apparatus 200 is substantially similar to the skin color detection apparatus 140 of FIG. 1. The skin color detection apparatus 200 is responsive to a table of parameters 220 and is configured to detect skin tones in input pixel data 222 using a series of consecutive tests.

The skin color detection apparatus 200 includes first circuitry 202 to perform a first test 204 using first parameters to determine whether a pixel has a hue corresponding to a skin hue range. The skin color detection apparatus 200 includes second circuitry 206 to perform a second test 208 using second parameters to determine whether the pixel has a luminance corresponding to a skin luminance range. The skin color detection apparatus 200 includes third circuitry 210 to perform a third test 212 using third parameters to determine whether the pixel has a saturation corresponding to a skin saturation range.

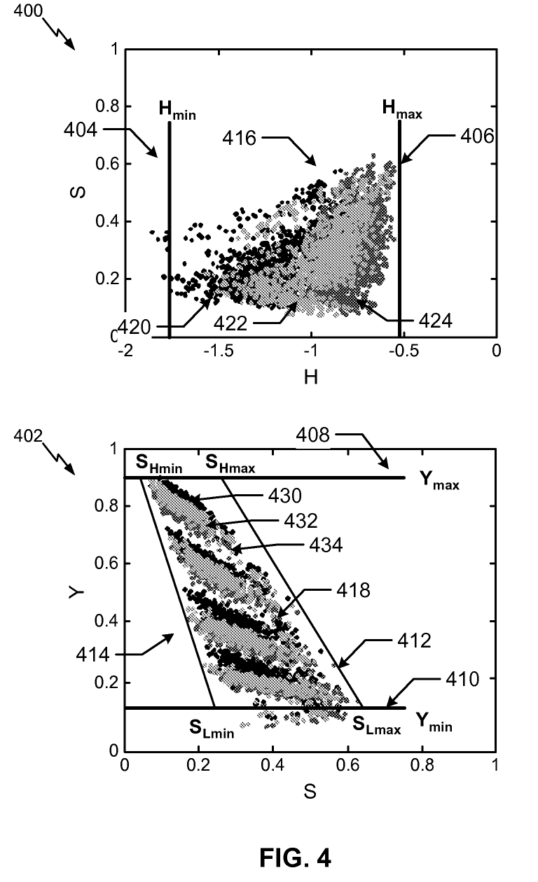

The table of parameters 220 may provide the first, second, and third parameters as inputs to the skin color detection apparatus 200. The table of parameters 220 includes parameters corresponding to skin color region boundaries in an HSY color space having a hue component, a saturation component, and a luminance component. The parameters corresponding to skin color regions in the HSY color space may be sensor-dependent and may include a minimum hue value Hₘᵢₙ, a maximum hue value Hₘₐₓ, a minimum luminance value Yₘᵢₙ, a maximum luminance value Yₘₐₓ, a minimum saturation value (at Yₘₐₓ) S_{H min}, a maximum saturation value (at Yₘₐₓ) S_{H max}, a minimum saturation value (at Yₘᵢₙ) S_{L min}, and a maximum saturation value (at Yₘᵢₙ) S_{L max}. An example of a skin color region in an HSY color space is illustrated in FIG. 4.

The input pixel data 222 include, for each pixel, values in a YCbCr color space having a luminance component, a blue chrominance component, and a red chrominance component. In a particular embodiment, each pixel is in image data corresponding to an image, such as the image 103 of FIG. 1, captured by an image sensor, such as the sensor 108 of FIG. 1. The hue value of a pixel may be given by

$$H = \frac{Cb}{Cr}$$

for a pixel having a blue chrominance value Cb and a red chrominance value Cr. The blue chrominance value Cb and the red chrominance value Cr of the pixel are input as CbCr data 224 to the first circuitry 202 to perform the first test 204 to determine whether the blue chrominance value Cb of the pixel satisfies HₘᵢₙCr<Cb<HₘₐₓCr. If the blue chrominance value Cb of the pixel satisfies HₘᵢₙCr<Cb<HₘₐₓCr, then the hue value H of the pixel satisfies

$${H}_{min} < H = \frac{Cb}{Cr} < {H}_{max}$$

and the pixel has a hue corresponding to a skin hue range.

An output of the first circuitry 202 may indicate whether the pixel satisfies the first test 204. The output may be provided to a first comparison circuit 226 to selectively provide the luminance value Y of the pixel as Y data 228 to the second circuitry 206 to perform the second test 208 to determine whether the luminance value Y of the pixel satisfies Yₘᵢₙ<Y<Yₘₐₓ. If the luminance value Y of the pixel satisfies Yₘᵢₙ<Y<Yₘₐₓ, then the pixel has a luminance corresponding to a skin luminance range.

An output of the second circuitry 206 may indicate whether the pixel satisfies the second test 208. The output may be provided to a second comparison circuit 230 to selectively provide the luminance value Y, the blue chrominance value Cb, and the red chrominance value Cr of the pixel as YCbCr data 232 to the third circuitry 210 to perform the third test 212. The saturation value of the pixel may be given by

$$S = \frac{C}{Y} ,$$

a ratio of a chroma value of the pixel to the luminance value of the pixel, where the chroma value C of the pixel may be given by

$$C = \frac{\vert Cb \vert + \vert Cr \vert}{2} ,$$

an average of the absolute values of the blue chrominance value Cb and the red chrominance value Cr of the pixel. The third test 212 determines whether the chroma value C of the pixel satisfies Sₘᵢₙ(Y)Y<C<Sₘₐₓ(Y)Y. Here Sₘᵢₙ(Y) is a minimum saturation value of the range of saturation values, dependent on the luminance value Y of the pixel, and may be given by

$${S}_{min} ( Y ) = {S}_{H min} + ( {S}_{L min} - {S}_{H min} ) \frac{{Y}_{max} - Y}{{Y}_{max} - {Y}_{min}} .$$

Similarly, Sₘₐₓ(Y) is a maximum saturation value of the range of saturation values, dependent on the luminance value Y of the pixel, and may be given by

$${S}_{max} ( Y ) = {S}_{H max} + ( {S}_{L max} - {S}_{H max} ) \frac{{Y}_{max} - Y}{{Y}_{max} - {Y}_{min}} .$$

If the chroma value C of the pixel satisfies Sₘᵢₙ(Y)Y<C<Sₘₐₓ(Y)Y, then the saturation value S of the pixel satisfies

$${S}_{min} ( Y ) < S = \frac{C}{Y} < {S}_{max} ( Y )$$

and the pixel has a saturation corresponding to a skin saturation range.

A skin color indicator 234 is output from the third circuitry 210 and input to fourth circuitry 236 to generate a skin tone map 238. The fourth circuitry 236 generates the skin tone map 238 based on results of the first test 204, the second test 208, and the third test 212. In a particular embodiment, the skin tone map 238 may be substantially similar to the skin tone map 144 of FIG. 1.

In a particular embodiment, the skin tone map 238 stores a single indicator corresponding to each block of pixels. For example, if the number of pixels indicating the presence of skin color is greater than or equal to a threshold number T for a block of pixels, then the single indicator stored in the skin tone map 238 corresponding to that block of pixels will indicate the presence of skin color. If the number of pixels indicating the presence of skin color is less than the threshold number T for a block of pixels, then the single indicator stored in the skin tone map 238 corresponding to that block of pixels will indicate the absence of skin color. For example, if each 4×4 block of pixels is compressed to a single indicator in the skin tone map 238, then a default threshold number T=12 may be used to generate the skin tone map 238. If each 4×4 block of pixels is compressed to a single indicator in the skin tone map 238, then the threshold number T may be in a range from 1 to 16.

In a particular embodiment, the first test 204, the second test 208, and the third test 212 are performed after a gamma correction operation and after a color conversion operation. In a particular embodiment, the color conversion operation includes converting from an RGB color space having a red component, a green component, and a blue component to a YCbCr color space having a luminance component, a blue chrominance component, and a red chrominance component using the matrix equation

$$[ \begin{matrix}Y \\ Cb \\ Cr\end{matrix} ] = [ \begin{matrix}0.299 & 0.587 & 0.114 \\ - 0.1687 & - 0.3313 & 0.5 \\ 0.5 & - 0.4187 & - 0.0813\end{matrix} ] [ \begin{matrix}R \\ G \\ B\end{matrix} ] .$$

As shown in FIG. 2, the testing of whether a pixel is in a skin color region in the HSY color space may be performed at the skin color detection apparatus 200 using YCbCr pixel data without having to convert the YCbCr pixel data to the HSY color space. The skin color detection apparatus 200 may efficiently process image data by rejecting a pixel if any of the tests fail so that subsequent tests are not performed on the pixel. The skin color region may be defined in the HSY color space using only constants and linear equations, resulting in efficient math processing. The processing performed at the skin color detection apparatus 200 may be done in real-time in a portable device.

In a particular embodiment, there may be other formulas that are useful for calculating hue or chroma or luminance, or any combination thereof In a particular embodiment, the formulas that are used for calculating hue or chroma or luminance, or any combination thereof, may be determined based on hardware calculation considerations, accuracy consideration, or other considerations.

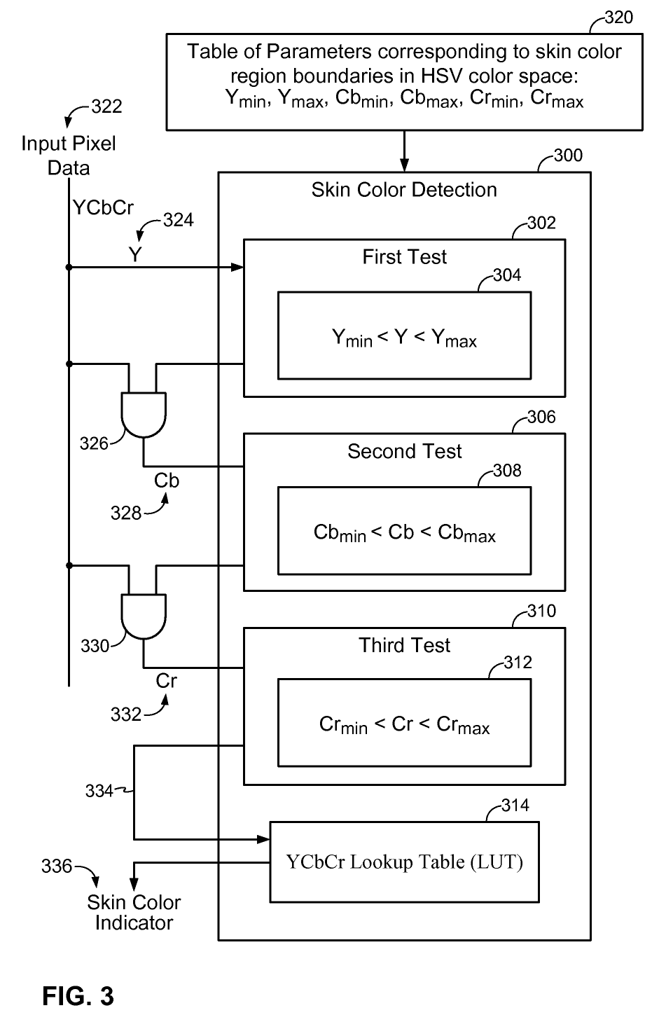

Referring to FIG. 3, another particular illustrative embodiment of a skin color detection apparatus 300 is depicted. In a particular embodiment, the skin color detection apparatus 300 may be substantially similar to the skin color detection apparatus 140 of FIG. 1. The skin color detection apparatus 300 is responsive to a table of parameters 320 and is configured to detect skin tones in input pixel data 322 using a series of consecutive tests.

The skin color detection apparatus 300 includes circuitry to perform a first test 302 using first parameters to determine whether a pixel has a luminance corresponding to a skin luminance range 304. The skin color detection apparatus 300 includes circuitry to perform a second test 306 using second parameters to determine whether the pixel has a blue chrominance corresponding to a skin blue chrominance range 308. The skin color detection apparatus 300 includes circuitry to perform a third test 310 using third parameters to determine whether the pixel has a red chrominance corresponding to a skin red chrominance range 312.

The table of parameters 320 may provide the first, second, and third parameters as inputs to the skin color detection apparatus 300. The table of parameters 320 includes parameters corresponding to skin color region boundaries in an HSV color space having a hue component, a saturation component, and a value component. The parameters corresponding to skin color region boundaries in the HSV color space include a minimum luminance value Yₘᵢₙ, a maximum luminance value Yₘₐₓ, a minimum blue chrominance value Cbₘᵢₙ, a maximum blue chrominance value Cbₘₐₓ, a minimum red chrominance value Crₘᵢₙ, and a maximum red chrominance value Crₘₐₓ.

The input pixel data 322 include, for each pixel, values in a YCbCr color space having a luminance component, a blue chrominance component, and a red chrominance component. The luminance value Y is input as Y data 324 to the circuitry to perform the first test 302 to determine whether the luminance value Y of the pixel satisfies Yₘᵢₙ<Y<Yₘₐₓ. If the luminance value Y of the pixel satisfies Yₘᵢₙ<Y<Yₘₐₓ, then the pixel has a luminance corresponding to the skin luminance range 304.

An output of the first test 302 may indicate whether the pixel satisfies the first test 302. The output may be provided to a first comparison circuit 326 to selectively provide the blue chrominance value Cb of the pixel as Cb data 328 to the circuitry to perform the second test 306 to determine whether the blue chrominance value Cb of the pixel satisfies Cbₘᵢₙ<Cb<Cbₘₐₓ. If the blue chrominance value Cb of the pixel satisfies Cbₘᵢₙ<Cb<Cbₘₐₓ, then the pixel has a blue chrominance corresponding to the skin blue chrominance range 308.

An output of the second test 306 may indicate whether the pixel satisfies the second test 306. The output may be provided to a second comparison circuit 330 to selectively provide the red chrominance value Cr of the pixel as Cr data 332 to the circuitry to perform the third test 310 to determine whether the red chrominance value Cr of the pixel satisfies Crₘᵢₙ<Cr<Crₘₐₓ. If the red chrominance value Cr of the pixel satisfies Crₘᵢₙ<Cr<Crₘₐₓ, then the pixel has a red chrominance corresponding to the skin red chrominance range 312.

An output 334 of the third test 310 is input to a YCbCr lookup table (LUT) 314. The YCbCr lookup table (LUT) 314 may indicate whether the luminance value of the pixel, the blue chrominance value of the pixel, and the red chrominance value of the pixel correspond to the skin portion of the image after performing the first test 302, the second test 306, and the third test 310. In a particular embodiment, the YCbCr lookup table (LUT) 314 is indexed by luminance values, blue chrominance values, and red chrominance values, and each table entry of the YCbCr lookup table (LUT) 314 indicates whether the pixel is within the skin color region of the HSV color space. The values stored at the lookup table may be independent of a sensor type. The lookup operation may be performed without transforming the pixel to the HSV color space.

The YCbCr lookup table (LUT) 314 may be condensed by subsampling the ranges of the luminance values, the blue chrominance values, and the red chrominance values. The subsampling may be performed using a bitwise right shift operation. In a particular embodiment, the YCbCr lookup table (LUT) 314 is compressed using a run-length encoding algorithm. In a particular embodiment, the ranges of the luminance values, the blue chrominance values, and the red chrominance values of the pixel are each from 0 to 255, and the YCbCr lookup table (LUT) 314 stores about 7 kilobytes.

A skin color indicator 336 may be output from the YCbCr lookup table (LUT) 314. As described above with respect to the skin color indicator 234 of FIG. 2, the skin color indicator 336 may be used to generate a skin tone map, such as the skin tone map 238 of FIG. 2.

Referring to FIG. 4, a particular illustrative embodiment of ranges of parameters defining a skin color region in an HSY color space having a hue component, a saturation component, and a luminance component is depicted. A projection onto the hue (H) and saturation (S) plane is shown at 400 and a projection onto the saturation (S) and luminance (Y) plane is shown at 402. In the hue (H) and saturation (S) plane at 400, a clustering of points 416 defining the skin color region in the HSY color space lies between a vertical line 404 at the minimum hue value Hₘᵢₙ and a vertical line 406 at the maximum hue value Hₘₐₓ. The clustering of points 416 defining the skin color region in the HSY color space includes a first set of points at 420, corresponding to skin color samples under daylight illumination, a second set of points at 422, corresponding to skin color samples under fluorescent light illumination, and a third set of points at 424, corresponding to skin color samples under tungsten/yellow light illumination.

In the saturation (S) and luminance (Y) plane at 402, a clustering of points 418 defining the skin color region in the HSY color space lies between a horizontal line 410 at the minimum luminance value Yₘᵢₙ and a horizontal line 408 at the maximum luminance value Yₘₐₓ. The clustering of points 418 defining the skin color region in the HSY color space lies between a line 414 at the minimum saturation values Sₘᵢₙ(Y) and a line 412 at the maximum saturation values Sₘₐₓ(Y). The line 414 may be given by

$${S}_{min} ( Y ) = {S}_{H min} + ( {S}_{L min} - {S}_{H min} ) \frac{{Y}_{max} - Y}{{Y}_{max} - {Y}_{min}} .$$

Similarly, the line 412 may be given by

$${S}_{max} ( Y ) = {S}_{H max} + ( {S}_{L max} - {S}_{H max} ) \frac{{Y}_{max} - Y}{{Y}_{max} - {Y}_{min}} .$$

The clustering of points 418 defining the skin color region in the HSY color space includes a fourth set of points at 430, corresponding to skin color samples under daylight illumination, a fifth set of points at 432, corresponding to skin color samples under fluorescent light illumination, and a sixth set of points at 434, corresponding to skin color samples under tungsten/yellow light illumination, for various values of hue (H). Because the clustering of points 418 defining the skin color region in the HSY color space may be accurately bounded by constants and linear functions, processing costs may be low to determine whether a particular pixel is in the skin color region, and it may be easy to translate from the YCbCr color space to the HSY color space.

In a particular embodiment, skin color data distributions in the HSY color space, such as those shown in FIG. 4, may be calculated offline with a limited amount of data, such as around 300 to around 400 skin color spectral distributions. Division operations may be performed offline, for example, in calculating hue (H). The parameters defining the skin color region in the HSY color space may be determined offline, while during image processing, for each pixel, no divisions may be performed for computational efficiency. In a particular embodiment, the skin colors may be clustered in the HSY color space so that the skin color region in the HSY color space may be well defined using constants and linear functions in part because the skin colors may be sensor dependent. In a particular embodiment, skin colors from different sensors or different image processing pipelines may be clustered differently in the HSY color space.

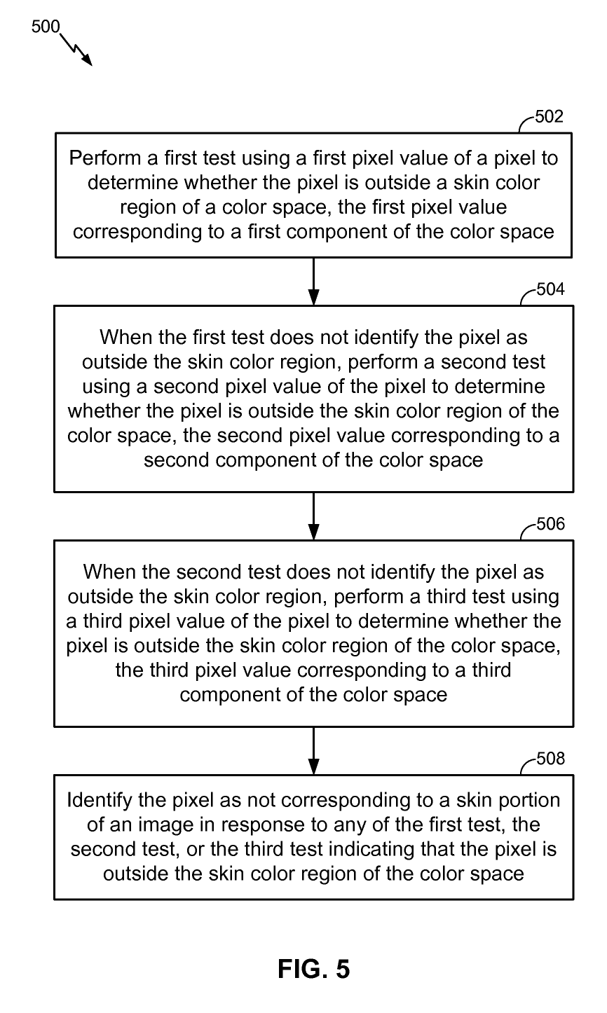

Referring to FIG. 5, a first illustrative embodiment of a method to detect skin color in an image is depicted at 500. The skin color detection apparatus 140 of FIG. 1 may operate in accordance with the method 500. The method 500 includes performing a first test using a first pixel value of a pixel to determine whether the pixel is outside a skin color region of a color space, the first pixel value corresponding to a first component of the color space, at 502. The method 500 further includes, when the first test does not identify the pixel as outside the skin color region, performing a second test using a second pixel value of the pixel to determine whether the pixel is outside the skin color region of the color space, the second pixel value corresponding to a second component of the color space, at 504. The method 500 also includes, when the second test does not identify the pixel as outside the skin color region, performing a third test using a third pixel value of the pixel to determine whether the pixel is outside the skin color region of the color space, the third pixel value corresponding to a third component of the color space, at 506. The method 500 further includes identifying the pixel as not corresponding to a skin portion of an image in response to any of the first test, the second test, or the third test indicating that the pixel is outside the skin color region of the color space, at 508.

In a particular embodiment, the color space is an HSY color space having a hue component (H), a saturation component (S), and a luminance component (Y). In a particular embodiment, the first component of the HSY color space used in the first test, at 502, is the hue component (H), the second component of the HSY color space used in the second test, at 504, is the luminance component (Y), and the third component of the HSY color space used in the third test, at 506, is the saturation component (S). In a particular embodiment, the first pixel value is a hue value of the pixel including a ratio of a blue chrominance value of the pixel to a red chrominance value of the pixel, and the first test determines whether the first pixel value is within a range of hue values by determining whether the blue chrominance value of the pixel is greater than a product of a minimum hue value of the range of hue values with the red chrominance value of the pixel and less than a product of a maximum hue value of the range of hue values with the red chrominance value of the pixel. In a particular embodiment, the first test determines whether the first pixel value

$$H = \frac{Cb}{Cr}$$

is within a range of hue values, where Cb is a blue chrominance value of the pixel and Cr is a red chrominance value of the pixel, by comparing HₘᵢₙCr<Cb<HₘₐₓCr, where Hₘᵢₙ is a minimum hue value of the range of hue values and Hₘₐₓ is a maximum hue value of the range of hue values. For example, the first test may be performed by the first circuitry 202 of FIG. 2.

In a particular embodiment, the second pixel value is a luminance value of the pixel and the second test determines whether the second pixel value is within a range of luminance values by determining whether the luminance value of the pixel is greater than a minimum luminance value of the range of luminance values and less than a maximum luminance value of the range of luminance values. In a particular embodiment, the second test determines whether the second pixel value Y is within a range of luminance values, by comparing Yₘᵢₙ<Y<Yₘₐₓ, where Yₘᵢₙ is a minimum luminance value of the range of luminance values and Yₘₐₓ is a maximum luminance value of the range of luminance values. For example, the second test may be performed by the second circuitry 206 of FIG. 2.

In a particular embodiment, the third pixel value is a saturation value of the pixel including a ratio of a chroma value of the pixel to the luminance value of the pixel, and the third test determines whether the third pixel value is within a range of saturation values, where the chroma value of the pixel is proportional to a sum of an absolute value of the blue chrominance value of the pixel and an absolute value of the red chrominance value of the pixel, by determining whether the chroma value of the pixel is greater than a product of Sₘᵢₙ(Y) with the luminance value of the pixel and less than a product of Sₘₐₓ(Y) with the luminance value of the pixel, where Sₘᵢₙ(Y) is a minimum saturation value of the range of saturation values dependent on luminance and Sₘₐₓ(Y) is a maximum saturation value of the range of saturation values dependent on luminance. In a particular embodiment, the third test determines whether the third pixel value

$$S = \frac{C}{Y}$$

is within a range of saturation values, where

$$C = \frac{\vert Cb \vert + \vert Cr \vert}{2} ,$$

by comparing Sₘᵢₙ(Y)Y<C<Sₘₐₓ(Y)Y, where Sₘᵢₙ(Y) is the minimum saturation value of the range of saturation values dependent on Y and Sₘₐₓ(Y) is the maximum saturation value of the range of saturation values also dependent on Y. For example, the third test may be performed by the third circuitry 210 of FIG. 2. In a particular embodiment, the minimum saturation value is determined as:

$${S}_{min} ( Y ) = {S}_{H min} + ( {S}_{L min} - {S}_{H min} ) \frac{{Y}_{max} - Y}{{Y}_{max} - {Y}_{min}} ,$$

and the maximum saturation value is determined as:

$${S}_{max} ( Y ) = {S}_{H max} + ( {S}_{L max} - {S}_{H max} ) \frac{{Y}_{max} - Y}{{Y}_{max} - {Y}_{min}} .$$

When Y=Yₘₐₓ,

Sₘᵢₙ(Y)=Sₘᵢₙ(Yₘₐₓ)=S_{H min} and Sₘₐₓ(Y)=Sₘₐₓ(Yₘₐₓ)=S_{H max}.

When Y=Yₘᵢₙ,

Sₘᵢₙ(Y)=Sₘᵢₙ(Yₘᵢₙ)=Sₘᵢₙ and Sₘₐₓ(Y)=Sₘₐₓ(Yₘᵢₙ)=S_{H max}.

In a particular embodiment, the first test, the second test, and the third test are performed without divisions. For example, the first test may be performed by comparing HₘᵢₙCr<Ch<HₘₐₓCr, which involves only multiplications and no divisions, the second test may be performed by comparing Yₘᵢₙ<Y<Yₘₐₓ, which involves no divisions, and the third test may be performed by comparing Sₘᵢₙ(Y)Y<C<Sₘₐₓ(Y)Y, which only involves multiplications without divisions. In a particular embodiment, the first test, the second test, and the third test include comparisons using sensor-dependent parameters.

In a particular embodiment, the first test, the second test, and the third test include comparisons using at most eight parameters. For example, the first test may be performed by comparing HₘᵢₙCr<Cb<HₘₐₓCr, which uses the parameters Hₘᵢₙ and Hₘₐₓ, the second test may be performed by comparing Yₘᵢₙ<Y<Yₘₐₓ, which uses the parameters Yₘᵢₙ and Yₘₐₓ, and the third test may be performed by comparing Sₘᵢₙ(Y)Y<C<Sₘₐₓ(Y)Y, which uses the parameters S_{H min}, S_{H max}, S_{L min}, and S_{L max}.

In a particular embodiment, the first test, the second test, and the third test include comparisons using parameters that are all within three orders of magnitude of each other. For example, the parameter Hₘᵢₙ may be in a range from about −3.0 to about −1.0, with a default value of about −1.5. The parameter Hₘₐₓ may be in a range from about −1.0 to about 0.0, with a default value of about −0.5. The parameter Yₘᵢₙ may be in a range from about 0.0 to about 0.3, with a default value of about 0.1. The parameter Yₘₐₓ may be in a range from about 0.7 to about 1.0, with a default value of about 0.9. The parameter S_{H min} may be in a range from about 0.0 to about 0.4, with a default value of about 0.05. The parameter S_{H max} may be in a range from about 0.1 to about 0.5, with a default value of about 0.25. The parameter S_{L min} may be in a range from about 0.0 to about 0.5, with a default value of about 0.25, and the parameter S_{L max} may be in a range from about 0.2 to about 1.0, with a default value of about 0.6.

In a particular embodiment, when the third test does not indicate a pixel is outside a skin color region, a value is written to a skin tone map indicating the pixel as corresponding to a skin color. For example, when the third test 212 of FIG. 2 does not indicate that a pixel is outside a skin color region, a value may be written to the skin tone map 238 indicating that the pixel corresponds to a skin color.

In another embodiment, the color space is an HSV color space that has a hue component (H), a saturation component (S), and a value component (V). A luminance value of the pixel, a blue chrominance value of the pixel, and a red chrominance value of the pixel may be compared to respective ranges of luminance values, blue chrominance values, and red chrominance values corresponding to the skin color region of the HSV color space. A lookup operation may be performed using a lookup table. The lookup table may indicate whether the luminance value of the pixel, the blue chrominance value of the pixel, and the red chrominance value of the pixel correspond to the skin portion of the image after performing the first test, the second test, and the third test.

In a particular embodiment, the lookup table is indexed by luminance values, blue chrominance values, and red chrominance values, and each table entry of the lookup table indicates whether the pixel is within the skin color region of the HSV color space. The values stored at the lookup table may be independent of a sensor type. The lookup operation may be performed without transforming the pixel to the HSV color space.

The lookup table may be condensed by subsampling the ranges of the luminance values, the blue chrominance values, and the red chrominance values. The subsampling may be performed using a bitwise right shift operation. In a particular embodiment, the lookup table is compressed using a run-length encoding algorithm. In a particular embodiment, the ranges of the luminance values, the blue chrominance values, and the red chrominance values of the pixel are each from 0 to 255, and the lookup table stores about 7 kilobytes.

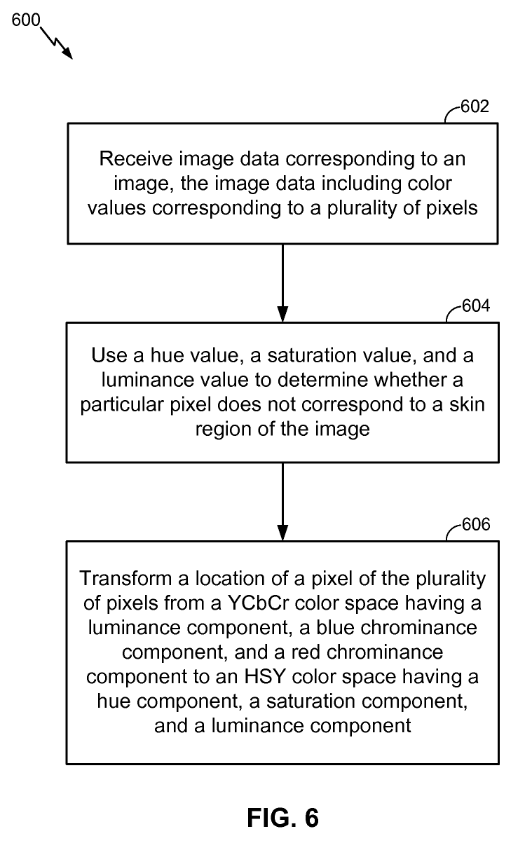

Referring to FIG. 6, a second illustrative embodiment of a method to detect skin color in an image is depicted at 600. In a particular embodiment, the method 600 is performed by the skin color detection apparatus 140 of FIG. 1. The method 600 includes receiving image data corresponding to an image, the image data including color values corresponding to a plurality of pixels, at 602. The method 600 also includes using a hue value, a saturation value, and a luminance value to determine whether a particular pixel does not correspond to a skin region of the image, at 604. The method 600 further includes transforming a location of a pixel of the plurality of pixels from a YCbCr color space having a luminance component (Y), a blue chrominance component (Cb), and a red chrominance component (Cr) to an HSY color space having a hue component (H), a saturation component (S), and a luminance component (Y), at 606.

In a particular embodiment, a hue value of the pixel includes a ratio of a blue chrominance value of the pixel to a red chrominance value of the pixel. In a particular embodiment, a hue value of the pixel is defined by

$$H = \frac{Cb}{Cr} ,$$

where Cb is a blue chrominance value of the pixel and Cr is a red chrominance value of the pixel. In a particular embodiment, a chroma value of the pixel is proportional to a sum of an absolute value of the blue chrominance value of the pixel and an absolute value of the red chrominance value of the pixel, and a saturation value of the pixel includes a ratio of the chroma value of the pixel to a luminance value of the pixel. In a particular embodiment, a chroma value of the pixel is defined by

$$C = \frac{( \vert Cb \vert + \vert Cr \vert )}{2} ,$$

and a saturation value of the pixel is defined by

$$S = \frac{C}{Y} ,$$

where Y is a luminance value of the pixel.

In a particular embodiment, the pixel is tested to determine whether the pixel is within a skin color region of the HSY color space, where the skin color region is completely defined by constants and linear equations. For example, as described above, the skin color region of the HSY color space may be completely defined by the relations

$${H}_{min} < H = \frac{Cb}{Cr} < {H}_{max} ,$$

which uses the constant parameters Hₘᵢₙ and Hₘₐₓ; Yₘᵢₙ<Y<Yₘₐₓ, which uses the constant parameters Yₘᵢₙ and Yₘₐₓ; and

$${S}_{min} ( Y ) < S = \frac{C}{Y} < {S}_{max} ( Y ) ,$$

which uses the constant parameters S_{H min}, S_{H max}, S_{L min}, and S_{L max} and the linear equations

$${S}_{min} ( Y ) = {S}_{H min} + ( {S}_{L min} - {S}_{H min} ) \frac{{Y}_{max} - Y}{{Y}_{max} - {Y}_{min}} , and$$

$${S}_{max} ( Y ) = {S}_{H max} + ( {S}_{L max} - {S}_{H max} ) \frac{{Y}_{max} - Y}{{Y}_{max} - {Y}_{min}} ,$$

as shown in FIG. 4.

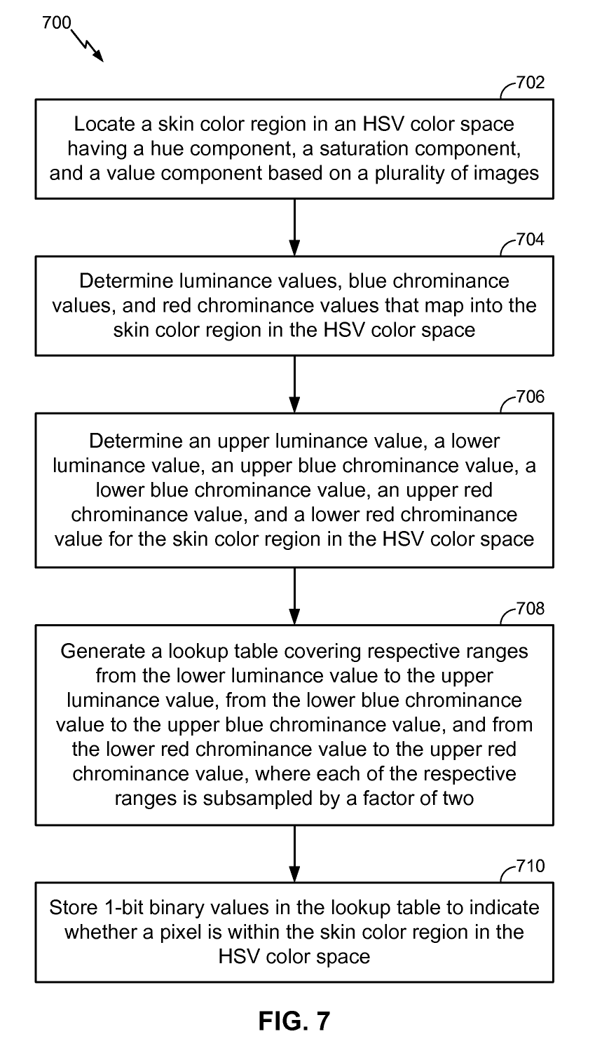

Referring to FIG. 7, a third illustrative embodiment of a method to detect skin color in an image is depicted and shown at 700. The method 700 includes locating a skin color region in an HSV color space having a hue component (H), a saturation component (S), and a value component (V) based on a plurality of images, at 702. The method 700 also includes determining luminance values, blue chrominance values, and red chrominance values that map into the skin color region in the HSV color space, at 704. The method 700 further includes determining an upper luminance value, a lower luminance value, an upper blue chrominance value, a lower blue chrominance value, an upper red chrominance value, and a lower red chrominance value for the skin color region in the HSV color space, at 706. The method 700 also includes generating a lookup table covering respective ranges from the lower luminance value to the upper luminance value, from the lower blue chrominance value to the upper blue chrominance value, and from the lower red chrominance value to the upper red chrominance value, where each of the respective ranges is subsampled by a factor of two, at 708. The method 700 further includes storing 1-bit binary values in the lookup table to indicate whether a pixel is within the skin color region in the HSV color space, at 710. In a particular embodiment, the lookup table is stored in a portable device. For example, the lookup table may be the YCbCr lookup table (LUT) 314 of FIG. 3.

In a particular embodiment, in order for a system to know what to detect, a user may feed or train the system with skin color samples taken from a tuned digital still camera with good auto white balance and good autoexposure or with pictures from the Internet, for example. Skin color regions may be copied to a blue image and fed to the system as a YCbCr image. For example, skin color samples may be taken from people of different ethnicities photographed under outdoor, D65, A, TL84, xenon flash, mixed, and unknown lighting conditions using several commercially available digital still cameras. In an alternative embodiment, the system may be used to detect foliage having undesirable colors that may be changed to more pleasant or more saturated colors. In another embodiment, the system may be used to detect blue sky and make the sky match what the sky should look like. In a particular embodiment, the background color from training images may be orthogonal in CbCr space to the color to be detected in order to reduce unintended pixels being used in the tuning process due to color blending at borders during JPEG encoding and conversion to the YCbCr color space.

In a particular embodiment, a user may pass an image to a tone-detection tuning tool to create HSV and YCbCr heat scatter plots. The user may then use the skin scatter plots in the HSV color space to program the system with regions that contain skin color. In a particular embodiment, the programming of the system with regions that contain skin color may be automated. Tuning may be done in the HSV color space because skin color clusters are more compact in the HSV color space than the YCbCr color space. Projected onto two dimensions, a few rectangles may be used to bound the more compact skin color clusters. In the YCbCr color space, many more rectangles or even ellipses may be needed. The HSV color space may be more forgiving if the user picks rectangles that are too big or too small, since pixels of the same hue are chosen either way. By contrast, too lenient of a classification in the YCbCr color space brings in green and blue and purple pixels, for example.

In a particular embodiment, when creating the heat maps of skin color pixels in the HSV color space, the images fed into the lookup table generator may be taken with a properly tuned camera so that the specific sensor that is used is not a factor. One point of tuning, using a Chromatix tool and MacBeth charts, for example, may be to remove any sensor dependencies so that the final picture looks ideal regardless of the sensor. The user may not know whether the picture has been taken with Micron or Omnivision, for example. Similarly, using a lookup table to see whether a given YCbCr pixel value is skin or not may be done on the image produced at the end of the color processing pipeline, where sensor dependencies have been removed. For example, even if a sensor tends to create images that are more blue-ish regardless of the lighting, proper tuning and setting of gains may make the pictures of this sensor match those produced with other sensors, allowing skin tone detection to work properly.

In a particular embodiment, the input image may be in YCbCr format, not in HSV format. However, converting every pixel may be very calculationally intensive. A lookup table may be used, instead. With Y and Cb and Cr ranging from 0 to 255, the lookup table would have a size of about (256)(256)(256)(3)=50 Mbytes. Subsampling Y, Cb, and Cr by 2 reduces the size to about (128)(128)(128)(3)=6.25 Mbytes. Restricting the ranges of Y, Cb, and Cr to the skin ranges, 60<Y<200, 88<Cb<128, and 120<Cr<200, and subsampling the reduced ranges by 2 gives a lookup table with a size of about (70)(20)(40)(3)=168 Kbytes. By not storing the HSV values and then checking to see if the HSV values are skin or not, but by building the logic into the lookup table itself, with a 1 if skin and a 0 if not, the size may be reduced to about (70)(20)(40)=56 Kbytes. By storing 1 bit per entry in the lookup table rather than 1 byte per entry and not wasting any bits, the size may be reduced to about (70)(20)(5)=7 Kbytes. In a particular embodiment, run-length encoding (RLE) may be used to reduce the size of the lookup table down to about 6 Kbytes.

In a particular embodiment, a first check may be made to see whether, for a given luma, a pixel's Cb and Cr values lie within a rectangle. If so, a lookup table may be used to convert the pixel's value to an HSV color space and confirm or deny whether the pixel corresponds to a skin color.

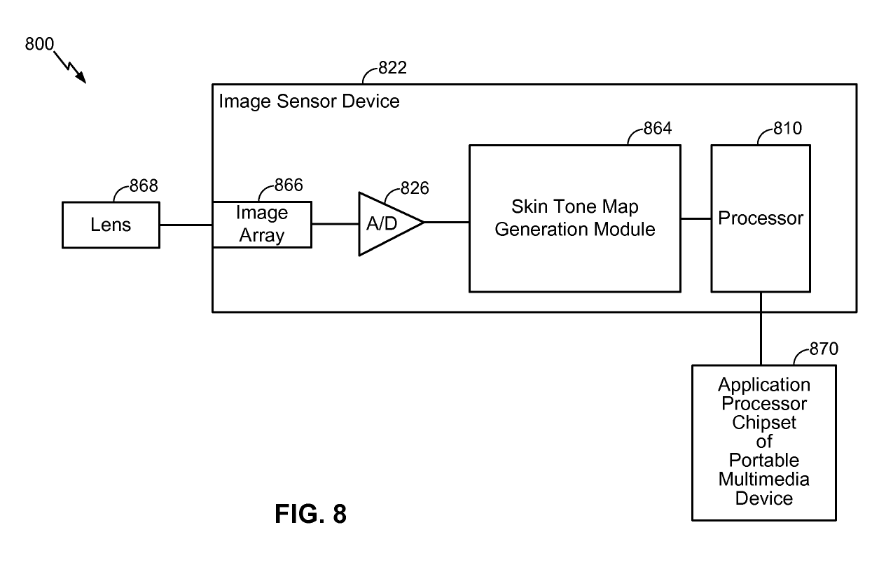

FIG. 8 is a block diagram of particular embodiment of a system including a skin tone map generation module. The system 800 includes an image sensor device 822 that is coupled to a lens 868 and also coupled to an application processor chipset of a portable multimedia device 870. The image sensor device 822 includes a skin tone map generation module 864 to generate a skin tone map, such as by implementing one or more of the systems of FIGS. 1-4, by operating in accordance with any of the embodiments of FIGS. 5-7, or any combination thereof.

The skin tone map generation module 864 is coupled to receive image data from an image array 866, such as via an analog-to-digital convertor 826 that is coupled to receive an output of the image array 866 and to provide the image data to the skin tone map generation module 864.

The image sensor device 822 may also include a processor 810. In a particular embodiment, the processor 810 is configured to implement the skin tone map generation module 864. In another embodiment, at least a portion of the skin tone map generation module 864 is implemented as image processing circuitry.

The processor 810 may also be configured to perform additional image processing operations, such as one or more of the operations performed by the image processing system 130 of FIG. 1. The processor 810 may provide processed image data to the application processor chipset of the portable multimedia device 870 for further processing, transmission, storage, display, or any combination thereof

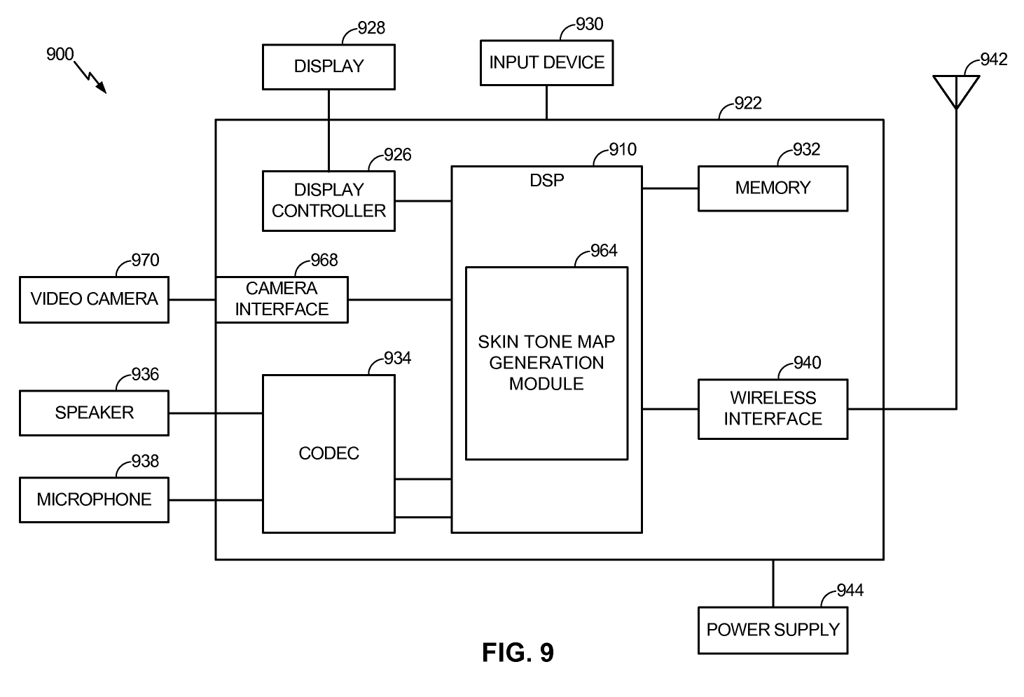

FIG. 9 is a block diagram of particular embodiment of a system including a skin tone map generation module. The system 900 may be implemented in a portable electronic device and includes a signal processor 910, such as a digital signal processor (DSP), coupled to a memory 932. The system 900 includes a skin tone map generation module 964. In an illustrative example, the skin tone map generation module 964 includes any of the systems of FIGS. 1-4, operates in accordance with any of the embodiments of FIGS. 5-7, or any combination thereof. The skin tone map generation module 964 may be in the signal processor 910 or may be a separate device or circuitry along a hardware image processing pipeline (not shown), or a combination thereof.

A camera interface 968 is coupled to the signal processor 910 and also coupled to a camera, such as a video camera 970. The camera interface 968 may be responsive to the skin tone map generation module 964, such as for autofocusing and autoexposure control. A display controller 926 is coupled to the signal processor 910 and to a display device 928. A coder/decoder (CODEC) 934 can also be coupled to the signal processor 910. A speaker 936 and a microphone 938 can be coupled to the CODEC 934. A wireless interface 940 can be coupled to the signal processor 910 and to a wireless antenna 942.

The signal processor 910 may also be adapted to generate processed image data. The display controller 926 is configured to receive the processed image data and to provide the processed image data to the display device 928. In addition, the memory 932 may be configured to receive and to store the processed image data, and the wireless interface 940 may be configured to receive the processed image data for transmission via the antenna 942.

In a particular embodiment, the signal processor 910, the display controller 926, the memory 932, the CODEC 934, the wireless interface 940, and the camera interface 968 are included in a system-in-package or system-on-chip device 922. In a particular embodiment, an input device 930 and a power supply 944 are coupled to the system-on-chip device 922. Moreover, in a particular embodiment, as illustrated in FIG. 9, the display device 928, the input device 930, the speaker 936, the microphone 938, the wireless antenna 942, the video camera 970, and the power supply 944 are external to the system-on-chip device 922. However, each of the display device 928, the input device 930, the speaker 936, the microphone 938, the wireless antenna 942, the video camera 970, and the power supply 944 can be coupled to a component of the system-on-chip device 922, such as an interface or a controller.

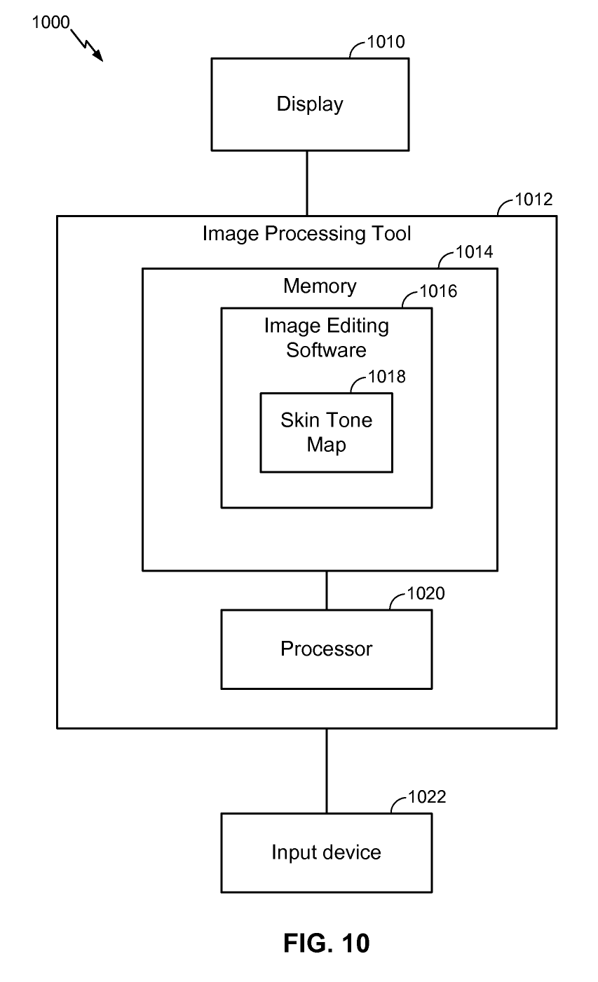

FIG. 10 is a block diagram of a particular embodiment of an image processing system 1000 including an image processing tool 1012 having image editing software 1016 using a skin tone map 1018. In a particular embodiment, the skin tone map 1018 may be substantially similar to the skin tone map 144 of FIG. 1 or to the skin tone map 238 of FIG. 2. The image processing tool 1012 includes a processor 1020 coupled to a computer-readable medium, such as a memory 1014.

The memory 1014 includes image editing software 1016, which may include the skin tone map 1018. The processor 1020 may be configured to execute the computer executable instructions of the image processing software 1016, such as programmed to perform one or more of the algorithms or methods of FIGS. 5-7, and to use the skin tone map 1018 in the editing of an image. In an alternative embodiment, the skin tone map 1018 is included in the memory 1014 separately from the image editing software 1016.

A display 1010 and an input device 1022 are also coupled to the image processing tool 1012. The input device 1022 may be used to input an image to be processed by the image processing tool 1012. The display 1010 may be used to display the image during the processing by the image processing tool 1012.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disk read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined by the following claims.

1. A method comprising:
performing a first test using a first pixel value of a pixel to determine whether the pixel is outside a skin color region of a color space, the first pixel value corresponding to a first component of the color space;
when the first test does not identify the pixel as outside the skin color region, performing a second test using a second pixel value of the pixel to determine whether the pixel is outside the skin color region of the color space, the second pixel value corresponding to a second component of the color space;
when the second test does not identify the pixel as outside the skin color region, performing a third test using a third pixel value of the pixel to determine whether the pixel is outside the skin color region of the color space, the third pixel value corresponding to a third component of the color space; and
identifying the pixel as not corresponding to a skin portion of an image in response to any of the first test, the second test, or the third test indicating that the pixel is outside the skin color region of the color space.

2. The method of claim 1, wherein the first component of the color space is a hue component, the second component of the color space is a luminance component, and the third component of the color space is a saturation component.

3. The method of claim 2, wherein the first pixel value is a hue value of the pixel including a ratio of a blue chrominance value of the pixel to a red chrominance value of the pixel, and wherein the first test determines whether the first pixel value is within a range of hue values by determining whether the blue chrominance value of the pixel is greater than a product of a minimum hue value of the range of hue values with the red chrominance value of the pixel and less than a product of a maximum hue value of the range of hue values with the red chrominance value of the pixel.

4. The method of claim 3, wherein the second pixel value is a luminance value of the pixel, and wherein the second test determines whether the second pixel value is within a range of luminance values by determining whether the luminance value of the pixel is greater than a minimum luminance value of the range of luminance values and less than a maximum luminance value of the range of luminance values.

5. The method of claim 4, wherein the third pixel value is a saturation value of the pixel including a ratio of a chroma value of the pixel to the luminance value of the pixel, and wherein the third test determines whether the third pixel value is within a range of saturation values, where the chroma value of the pixel is proportional to a sum of an absolute value of the blue chrominance value of the pixel and an absolute value of the red chrominance value of the pixel, by determining whether the chroma value of the pixel is greater than a product of Sₘᵢₙ(Y) with the luminance value of the pixel and less than a product of Sₘₐₓ(Y) with the luminance value of the pixel, where Sₘᵢₙ(Y) is a minimum saturation value of the range of saturation values dependent on luminance and Sₘₐₓ(Y) is a maximum saturation value of the range of saturation values dependent on luminance.

6. The method of claim 5, wherein the minimum saturation value
$${S}_{min} ( Y ) = {S}_{H min} + ( {S}_{L min} - {S}_{H min} ) \frac{{Y}_{max} - Y}{{Y}_{max} - {Y}_{min}} ,$$
and the maximum saturation value
$${S}_{max} ( Y ) = {S}_{H max} + ( {S}_{L max} - {S}_{H max} ) \frac{{Y}_{max} - Y}{{Y}_{max} - {Y}_{min}} .$$

7. The method of claim 2, further comprising, when the third test does not indicate the pixel is outside the skin color region, writing a value to a skin tone map indicating the pixel as corresponding to a skin color.

8. The method of claim 1, wherein the color space is an HSV color space that has a hue component, a saturation component, and a value component, and wherein a luminance value of the pixel, a blue chrominance value of the pixel, and a red chrominance value of the pixel are compared to respective ranges of luminance values, blue chrominance values, and red chrominance values corresponding to the skin color region of the HSV color space, and further comprising performing a lookup operation using a lookup table, the lookup table indicating whether the luminance value of the pixel, the blue chrominance value of the pixel, and the red chrominance value of the pixel correspond to the skin portion of the image after performing the first test, the second test, and the third test.

9. The method of claim 8, wherein the lookup table is indexed by luminance values, blue chrominance values, and red chrominance values, and each table entry of the lookup table indicates whether the pixel is within the skin color region of the HSV color space.

10. The method of claim 8, wherein values stored at the lookup table are independent of a sensor type.

11. The method of claim 8, wherein the lookup operation is performed without transforming the pixel to the HSV color space.

12. A method comprising:
receiving image data corresponding to an image, the image data including color values corresponding to a plurality of pixels;
using a hue value, a saturation value, and a luminance value to determine whether a particular pixel does not correspond to a skin region of the image; and
transforming a location of a pixel of the plurality of pixels from a YCbCr color space having a luminance component, a blue chrominance component, and a red chrominance component to an HSY color space having a hue component, a saturation component, and a luminance component.

13. The method of claim 12, wherein a hue value of the pixel includes a ratio of a blue chrominance value of the pixel to a red chrominance value of the pixel.

14. The method of claim 13, wherein a chroma value of the pixel is proportional to a sum of an absolute value of the blue chrominance value of the pixel and an absolute value of the red chrominance value of the pixel, and wherein a saturation value of the pixel includes a ratio of the chroma value of the pixel to a luminance value of the pixel.

15. The method of claim 14, wherein the pixel is tested to determine whether the pixel is within a skin color region of the HSY color space, wherein the skin color region is completely defined by constants and linear equations.

16. An apparatus comprising:
first circuitry to perform a first test using first parameters to determine whether a pixel has a hue corresponding to a skin hue range;
second circuitry to perform a second test using second parameters to determine whether the pixel has a luminance corresponding to a skin luminance range; and
third circuitry to perform a third test using third parameters to determine whether the pixel has a saturation corresponding to a skin saturation range.

17. The apparatus of claim 16, further comprising:
fourth circuitry to generate a skin tone map based on results of the first test, the second test, and the third test, wherein the skin tone map stores a single indicator corresponding to each block of pixels.

18. The apparatus of claim 17, further comprising:
an autoexposure controller configured to receive the skin tone map to determine an exposure setting based on a region of an image having skin color.

19. The apparatus of claim 17, further comprising:
an autofocus controller configured to receive the skin tone map to focus based on a window of an image having skin color.

20. A computer-readable medium containing computer executable instructions that are executable to cause a computer to:
receive image data corresponding to an image, the image data including color values corresponding to a plurality of pixels;
determine when a particular pixel corresponds to a skin region of the image based on a hue value, a saturation value, and a luminance value; and
transform a location of a pixel of the plurality of pixels from a YCbCr color space having a luminance component, a blue chrominance component, and a red chrominance component to an HSY color space having a hue component, a saturation component, and a luminance component.

21. The computer-readable medium of claim 20, wherein a hue value of the pixel includes a ratio of a blue chrominance value of the pixel to a red chrominance value of the pixel, wherein a chroma value of the pixel is proportional to a sum of an absolute value of the blue chrominance value of the pixel and an absolute value of the red chrominance value of the pixel, and wherein a saturation value of the pixel includes a ratio of the chroma value of the pixel to a luminance value of the pixel.

22. The computer-readable medium of claim 21, wherein the pixel is tested to determine whether the pixel is within a skin color region of the HSY color space, wherein the skin color region is completely defined by constants and linear equations.

23. A computer-readable medium containing computer executable instructions that are executable to cause a computer to:
locate a skin color region in an HSV color space having a hue component, a saturation component, and a value component based on a plurality of images;
determine luminance values, blue chrominance values, and red chrominance values that map into the skin color region in the HSV color space;
determine an upper luminance value, a lower luminance value, an upper blue chrominance value, a lower blue chrominance value, an upper red chrominance value, and a lower red chrominance value for the skin color region in the HSV color space; and
generate a lookup table covering respective ranges from the lower luminance value to the upper luminance value, from the lower blue chrominance value to the upper blue chrominance value, and from the lower red chrominance value to the upper red chrominance value, wherein each of the respective ranges is subsampled by a factor of two.

24. The computer-readable medium of claim 23, wherein the computer executable instructions are further executable to cause the computer to:
store 1-bit binary values in the lookup table to indicate whether a pixel is within the skin color region in the HSV color space.

25. The computer-readable medium of claim 24, wherein the lookup table is stored in a portable device.

26. An apparatus comprising:
means for performing a first test using first parameters to determine whether a pixel has a hue corresponding to a skin hue range;
means for performing a second test using second parameters to determine whether the pixel has a luminance corresponding to a skin luminance range; and
means for performing a third test using third parameters to determine whether the pixel has a saturation corresponding to a skin saturation range.
